(19) United States
(12) Patent Application Publication
(10) Pub. No.: US 2018/0144500 A1
(43) Pub. Date: May 24, 2018

(54) COMPUTER PROGRAM, POSE DERIVATION METHOD, AND POSE DERIVATION DEVICE

(71) Applicant: SEIKO EPSON CORPORATION, Tokyo (JP)

(72) Inventors: Joseph Chitai LAM, Toronto (CA); Alex LEVINSHTEIN, Vaughan (CA)

(73) Assignee: SEIKO EPSON CORPORATION, Tokyo (JP)

(21) Appl. No.: 15/818,031

(22) Filed: Nov. 20, 2017

(30) Foreign Application Priority Data
Nov. 24, 2016 (JP) 2016-227595

(51) Int. Cl. G06T 7/73; G06T 7/13

(52) U.S. Cl. CPC G06T 7/75; G06T 7/13; G06T 7/136; G06T 2207/20212; G06T 2207/10028

(57) ABSTRACT

A method includes : obtaining a first 3D model point cloud associated with surface feature elements of a 3D model corresponding to a real object; obtaining a 3D surface point cloud from current depth image data of the real object; obtaining a second 3D model point cloud associated with 2D model points in a model contour; obtaining a 3D image contour point cloud at respective intersections of first imaginary lines and second imaginary lines; and deriving a second pose based at least on the first 3D model point cloud, the 3D surface point cloud, the second 3D model point cloud, the 3D image contour point cloud and the first pose.

### BACKGROUND

### 1. Technical Field

This disclosure relates to the derivation of a pose of a real object.

### 2. Related Art

Paul J. Besl, Neil D. McKay, “A Method for Registration of 3-D Shapes,” IEEE Transactions on Pattern Analysis and Machine Intelligence (United States), IEEE Computer Society, February 1992, Vol. 14, No. 2, pp. 239-256 discloses the ICP method. The ICP is the abbreviation of iterative closest point. The ICP method refers to the algorithm used to minimize the difference between two point clouds (to match two point clouds).

### SUMMARY

An advantage of the disclosure is that a pose can be derived with higher accuracy than with the known ICP method.

The disclosure can be implemented as the following configurations.

An aspect of the disclosure is directed to a non-transitory storage medium containing program instructions that, when executed by a processor, cause the processor to perform a method including: obtaining a first 3D model point cloud associated with surface feature elements of a 3D model corresponding to a real object in a scene, the first 3D model point cloud being on the 3D model; obtaining a 3D surface point cloud from current depth image data of the real object captured with a depth image sensor; obtaining a second 3D model point cloud associated with 2D model points in a model contour that is obtained from projection of the 3D model onto an image plane using a first pose of the 3D model, the second 3D model point cloud being on the 3D model; obtaining a 3D image contour point cloud at respective intersections of first imaginary lines and second imaginary lines, the first imaginary lines passing through image points and the origin of a 3D coordinate system of an image sensor, the image points being obtained from current intensity image data of the real object captured with the image sensor and corresponding to the 2D model points included in the model contour, the second imaginary lines passing through the second 3D point cloud and being perpendicular to the first imaginary lines; and deriving a second pose based at least on the first 3D model point cloud, the 3D surface point cloud, the second 3D model point cloud, the 3D image contour point cloud and the first pose. According to the aspect of the disclosure, the second pose is derived using the intensity image data in addition to the depth image data and the 3D model. Therefore, the second pose can be derived with high accuracy.

In the aspect of the disclosure, the first pose may be a pose of the real object in a frame before a current frame of the depth image data or the intensity image data. The second pose may be a pose of the real object in the current frame of the depth image data or the intensity image data. According to this configuration, since the future first pose is decided based on the second pose, the future first pose can be derived with high accuracy.

In the non-transitory storage medium, the first pose may be a pose obtained from the image sensor or another image sensor. According to this configuration, the first pose can be easily derived and the processing load is reduced.

The disclosure can be realized in various other configurations, for example, in the form of a pose derivation method or a device which realizes this method.

Another aspect of the disclosure is directed to a method for deriving a pose of a real object in a scene including steps of: obtaining a first 3D model point cloud associated with surface feature elements of a 3D model corresponding to a real object in a scene, the first 3D model point cloud being on the 3D model; obtaining a 3D surface point cloud from current depth image data of the real object captured with a depth image sensor; obtaining a second 3D model point cloud associated with 2D model points in a model contour that is obtained from projection of the 3D model onto an image plane using a first pose of the 3D model, the second 3D model point cloud being on the 3D model; obtaining a 3D image contour point cloud at respective intersections of first imaginary lines and second imaginary lines, the first imaginary lines passing through image points and the origin of a 3D coordinate system of an image sensor, the image points being obtained from current intensity image data of the real object captured with the image sensor and corresponding to the 2D model points included in the model contour, the second imaginary lines passing through the second 3D point cloud and being perpendicular to the first imaginary lines; and deriving a second pose based at least on the first 3D model point cloud, the 3D surface point cloud, the second 3D model point cloud, the 3D image contour point cloud and the first pose.

Still another aspect of the disclosure is directed to a pose derivation device including: a function of obtaining a first 3D model point cloud associated with surface feature elements of a 3D model corresponding to a real object in a scene, the first 3D model point cloud being on the 3D model; a function of obtaining a 3D surface point cloud from current depth image data of the real object captured with a depth image sensor; a function of obtaining a second 3D model point cloud associated with 2D model points in a model contour that is obtained from projection of the 3D model onto an image plane using a first pose of the 3D model, the second 3D model point cloud being on the 3D model; a function of obtaining a 3D image contour point cloud at respective intersections of first imaginary lines and second imaginary lines, the first imaginary lines passing through image points and the origin of a 3D coordinate system of an image sensor, the image points being obtained from current intensity image data of the real object captured with the image sensor and corresponding to the 2D model points included in the model contour, the second imaginary lines passing through the second 3D point cloud and being perpendicular to the first imaginary lines; and a function of deriving a second pose based at least on the first 3D model point cloud, the 3D surface point cloud, the second 3D model point cloud, the 3D image contour point cloud and the first pose.

### BRIEF DESCRIPTION OF THE DRAWINGS

The disclosure will be described with reference to the accompanying drawings, wherein like numbers reference like elements.

FIG. 1 shows the schematic configuration of an HMD.

FIG. 2 is a functional block diagram of the HMD.

FIG. 3 is a flowchart showing pose derivation processing.

FIG. 4 shows a neighbor discovery range.

FIG. 5 is a flowchart showing a contour feature (CF) method.

FIG. 6 shows the way a 3D image CF point is obtained, based on a 3D model CF point.

FIG. 7 shows an example of similarity score calculation.

FIG. 8 shows an example of similarity score calculation.

FIG. 9 shows an example of similarity score calculation.

FIG. 10 shows an example of similarity score calculation.

FIG. 11 shows an example of similarity score calculation.

FIG. 12 shows that a 2D model point is matched with multiple image points.

FIG. 13 shows an example in which 2D model points are matched with wrong image points.

### DESCRIPTION OF EXEMPLARY EMBODIMENTS

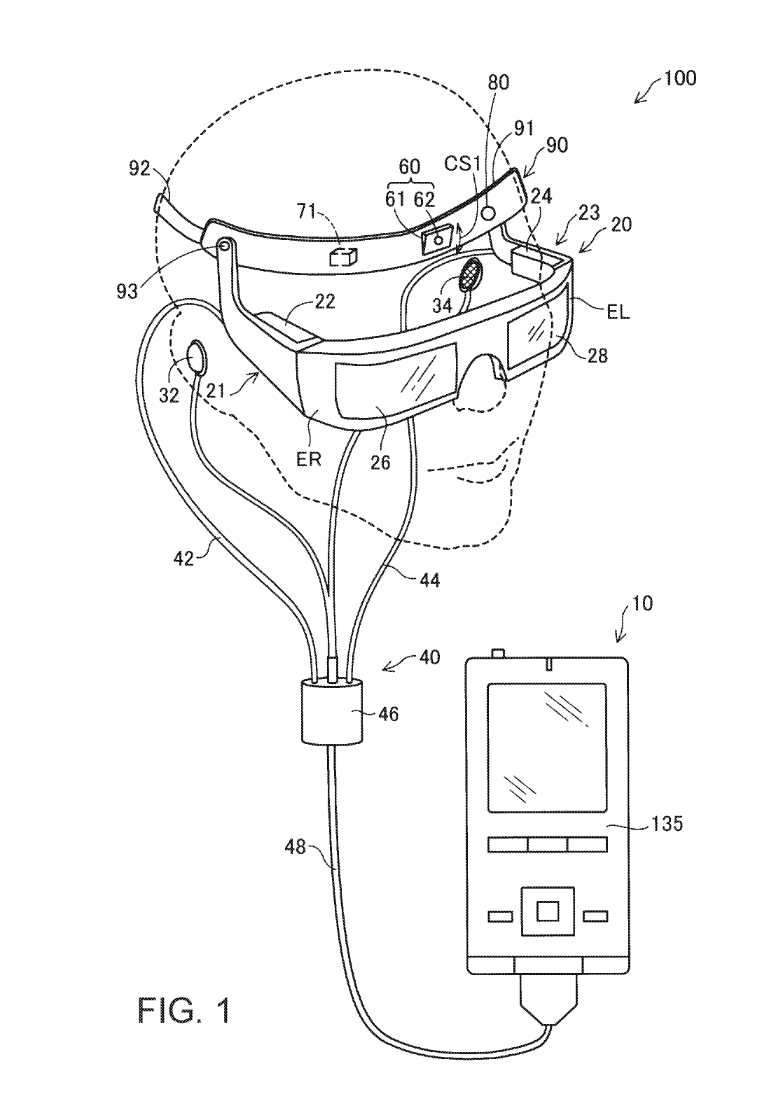

FIG. 1 shows the schematic configuration of an HMD 100. The HMD 100 is a head-mounted display. The HMD 100 is an optical transmitting-type device. That is, the HMD 100 can allow the user to perceive a virtual image and at the same time directly visually recognize the background. The HMD 100 functions as a device which derives the pose of a real object, as described later. That is, the HMD 100 executes a method for deriving the pose of a real object.

The HMD 100 has an attachment strap 90 which can be attached to the head of the user, a display section 20 which displays an image, and a control section 10 which controls the display section 20. The display section 20 allows the user to perceive a virtual image in the state where the HMD 100 is mounted on the head of the user. The display section 20 allowing the user to perceive a virtual image is also referred to as “displaying AR”. The virtual image perceived by the user is also referred to as an AR image.

The attachment strap 90 includes a wearing base section 91 made of resin, a cloth belt section 92 connected to the wearing base section 91, a camera 60, an inertial sensor 71, and a depth image sensor 80. The wearing base section 91 is curved to follow the shape of the human forehead. The belt section 92 is attached around the head of the user.

The camera 60 is an RGB sensor and image sensor. The camera 60 can capture an image of the background (scene) and is arranged at a center part of the wearing base section 91. In other words, the camera 60 is arranged at a position corresponding to the middle of the forehead of the user in the state where the attachment strap 90 is attached to the head of the user. Therefore, in the state where the user wears the attachment strap 90 on his/her head, the camera 60 captures an image of the background, which is the scenery of the outside in the direction of the user's line of sight, and acquires intensity image data as a captured image.

The camera 60 includes a camera base 61 which rotates about the wearing base section 91, and a lens part 62 fixed in relative position to the camera base 61. The camera base 61 is arranged in such a way as to be able to rotate along an arrow CS1, which is a predetermined range of an axis included in the plane including the center axis of the user when the attachment strap 90 is attached to the head of the user. Therefore, the optical axis of the lens part 62, which is the optical axis of the camera 60, is changeable in direction within the range of the arrow CS1. The lens part 62 captures a range which changes according to zooming in or out about the optical axis.

The depth image sensor 80 is also referred to as a depth sensor or distance image sensor. The depth image sensor 80 acquires depth image data.

The inertial sensor 71 is a sensor which detects acceleration, and is hereinafter referred to as an IMU (inertial measurement unit) 71. IMU 71 can detect angular velocity and geomagnetism in addition to acceleration. The IMU 71 is arranged inside the wearing base section 91. Therefore, the IMU 71 detects the acceleration, angular velocity and geomagnetism of the attachment strap 90 and the camera base 61.

Since the IMU 71 is fixed in relative position to the wearing base section 91, the camera 60 is movable with respect to the IMU 71. Also, since the display section 20 is fixed in relative position to the wearing base section 91, the camera 60 is movable in relative position to the display section 20.

The display section 20 is connected to the wearing base section 91 of the attachment strap 90. The display section 20 is in the shape of eyeglasses. The display section 20 includes a right holding section 21, a right display drive section 22, a left holding section 23, a left display drive section 24, a right optical image display section 26, and a left optical image display section 28.

The right optical image display section 26 and the left optical image display section 28 are situated in front of the right and left eyes of the user, respectively, when the user wears the display section 20. One end of the right optical image display section 26 and one end of the left optical image display section 28 are connected together at a position corresponding to the glabella of the user when the user wears the display section 20.

The right holding section 21 has a shape extending substantially in a horizontal direction from an end part ER, which is the other end of the right optical image display section 26, and tilted obliquely upward from a halfway part. The right holding section 21 connects the end part ER with a coupling section 93 on the right-hand side of the wearing base section 91.

Similarly, the left holding section 23 has a shape extending substantially in a horizontal direction from an end part EL, which is the other end of the left optical image display section 28, and tilted obliquely upward from a halfway part. The left holding section 23 connects the end part EL with a coupling section (not illustrated) on the left-hand side of the wearing base section 91.

As the right holding section 21 and the left holding section 23 are connected to the wearing base section 91 via the right and left coupling sections 93, the right optical image display section 26 and the left optical image display section 28 are situated in front of the eyes of the user. The respective coupling sections 93 connect the right holding section 21 and the left holding section 23 in such a way that these holding sections can rotate and can be fixed at arbitrary rotating positions. As a result, the display section 20 is provided rotatably to the wearing base section 91.

The right holding section 21 is a member extending from the end part ER, which is the other end of the right optical image display section 26, to a position corresponding to the temporal region of the user when the user wears the display section 20.

Similarly, the left holding section 23 is a member extending from the end part EL, which is the other end of the left optical image display section 28, to a position corresponding to the temporal region of the user when the user wears the display section 20. The right display drive section and the left display drive section 24 (hereinafter collectively referred to as the display drive sections) are arranged on the side facing the head of the user when the user wears the display section 20.

The display drive sections include a right liquid crystal display 241 (hereinafter right LCD 241), a left liquid crystal display 242 (hereinafter left LCD 242), a right projection optical system 251, a left projection optical system 252 and the like. Detailed explanation of the configuration of the display drive sections will be given later.

The right optical image display section 26 and the left optical image display section 28 (hereinafter collectively referred to as the optical image display sections) include a right light guide plate 261 and a left light guide plate 262 (hereinafter collectively referred to as the light guide plates) and also include a light control plate. The light guide plates are formed of a light-transmissive resin material or the like and guide image light outputted from the display drive section to the eyes of the user.

The light control plate is a thin plate-like optical element and is arranged in such a way as to cover the front side of the display section 20, which is opposite to the side of the eyes of the user. By adjusting the light transmittance of the light control plate, the amount of external light entering the user's eyes can be adjusted and the visibility of the virtual image can be thus adjusted.

The display section 20 also includes a connecting section 40 for connecting the display section 20 to the control section 10. The connecting section 40 includes a main body cord 48, a right cord 42, a left cord 44, and a connecting member 46.

The right cord 42 and the left cord 44 are two branch cords split from the main body cord 48. The display section 20 and the control section 10 execute transmission of various signals via the connecting section 40. For the right cord 42, the left cord 44 and the main body cord 48, metal cables or optical fibers can be employed, for example.

The control section 10 is a device for controlling the HMD 100. The control section 10 has an operation section 135 including an electrostatic track pad or a plurality of buttons which can be pressed, or the like. The operation section 135 is arranged on the surface of the control section 10.

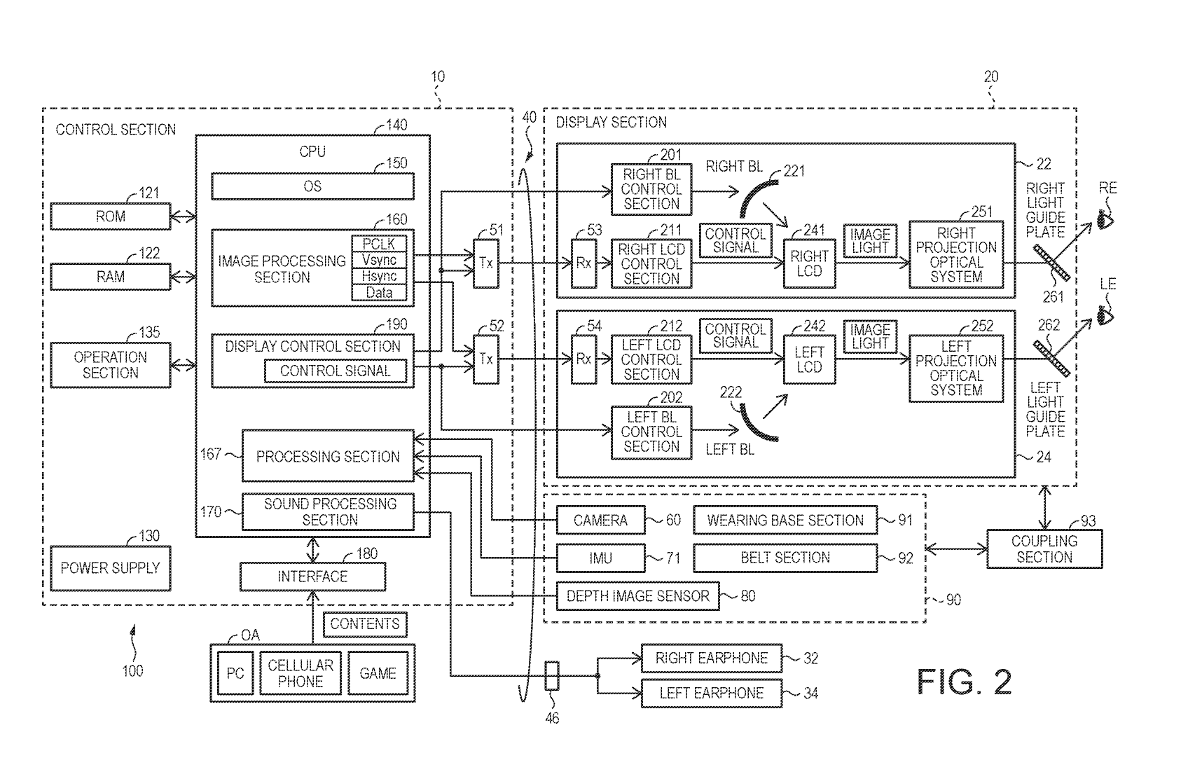

FIG. 2 is a block diagram functionally showing the configuration of the HMD 100. As shown in FIG. 2, the control section 10 has a ROM 121, a RAM 122, a power supply 130, the operation section 135, a CPU 140, an interface 180, a sending section 51 (Tx51), and a sending section 52 (Tx52).

The power supply 130 supplies electricity to each part of the HMD 100. In the ROM 121, various programs are stored. The central processing unit (CPU) 140 develops the various programs stored in the ROM 121 into the RAM 122 and thus executes the various programs. The CPU 140 may include one or more processors. The various programs include a program having instructions for realizing pose derivation processing, described later.

The CPU 140 develops programs stored in the ROM 121 into the RAM 122 and thus functions as an operating system 150 (OS 150), a display control section 190, a sound processing section 170, an image processing section 160, and a processing section 167.

The display control section 190 generates a control signal to control the right display drive section 22 and the left display drive section 24. The display control section 190 controls the generation and emission of image light by each of the right display drive section 22 and the left display drive section 24.

The display control section 190 sends each of control signals for a right LCD control section 211 and a left LCD control section 212 via the sending sections 51 and 52. The display control section 190 sends each of control signals for a right backlight control section 201 and a left backlight control section 202.

The image processing section 160 acquires an image signal included in a content and sends the acquired image signal to a receiving section 53 and a receiving section 54 of the display section 20 via the sending section 51 and the sending section 52. The sound processing section 170 acquires an audio signal included in a content, then amplifies the acquired audio signal, and supplies the amplified audio signal to a speaker (not illustrated) in a right earphone 32 connected to the connecting member 46 or to a speaker (not illustrated) in a left earphone 34.

The processing section 167 calculates a pose of a real object by nomography matrix, or by methods described later, for example. The pose of a real object is the spatial relationship between the camera 60 and the real object. The processing section 167 may calculate a rotation matrix to convert from a coordinate system fixed on the camera to a coordinate system fixed on the IMU 71, using the calculated spatial relationship and the detection value of acceleration or the like detected by the IMU 71. The functions of the processing section 167 are used for the pose derivation processing, described later.

The interface 180 is an input/output interface for connecting various external devices OA which serve as content supply sources, to the control section 10. The external devices Camay include a storage device, personal computer (PC), cellular phone terminal, game terminal and the like storing an AR scenario, for example. As the interface 180, a USB interface, micro USB interface, memory card interface or the like can be used, for example.

The display section 20 has the right display drive section 22, the left display drive section 24, the right light guide plate 261 as the right optical image display section 26, and the left light guide plate 262 as the left optical image display section 28.

The right display drive section 22 includes the receiving section 53 (Rx53), the right backlight control section 201, a right backlight 221, the right LCD control section 211, the right LCD 241, and the right projection optical system 251. The right backlight control section 201 and the right backlight 221 function as a light source.

The right LCD control section 211 and the right LCD 241 function as a display element. Meanwhile, in other embodiments, the right display drive section 22 may have a self-light-emitting display element such as an organic EL display element, or a scanning display element which scans the retina with a light beam from a laser diode, instead of the above configuration. The same applies to the left display drive section 24.

The receiving section 53 functions as a receiver for serial transmission between the control section 10 and the display section 20. The right backlight control section 201 drives the right backlight 221, based on a control signal inputted thereto. The right backlight 221 is a light-emitting member such as an LED or electroluminescence (EL), for example. The right LCD control section 211 drives the right LCD 241, based on control signals sent from the image processing section 160 and the display control section 190. The right LCD 241 is a transmission-type liquid crystal panel in which a plurality of pixels is arranged in the form of a matrix.

The right projection optical system 251 is made up of a collimating lens which turns the image light emitted from the right LCD 241 into a parallel luminous flux. The right light guide plate 261 as the right optical image display section 26 guides the image light outputted from the right projection optical system 251 to the right eye RE of the user while reflecting the image light along a predetermined optical path. The left display drive section 24 has a configuration similar to that of the right display drive section 22 and corresponds to the left eye LE of the user and therefore will not be described further in detail.

Calibration using the IMU 71 and the camera 60 varies in accuracy, depending on the capability of the IMU 71 as an inertial sensor. If an inexpensive IMU with lower accuracy is used, significant errors and drifts may occur in the calibration.

In the embodiment, calibration is executed, based on a batch solution-based algorithm using a multi-position method with the IMU 71. In the embodiment, design data obtained in manufacturing is used for the translational relationship between the IMU 71 and the camera 60.

Calibration is executed separately for the IMU 71 and for the camera 60 (hereinafter referred to as independent calibration). As a specific method of independent calibration, a known technique is used.

In the independent calibration, the IMU 71 is calibrated. Specifically, with respect to a 3-axis acceleration sensor (Ax, Ay, Az), a 3-axis gyro sensor (Gx, Gy, Gz), and a 3-axis geomagnetic sensor (Mx, My, Mz) included in the IMU 71, the gain/scale, static bias/offset, and skew among the three axes are calibrated.

As these calibrations are executed, the IMU 71 outputs acceleration, angular velocity, and geomagnetism, as output values of the respective sensors for acceleration, angular velocity, and geomagnetism. These output values are obtained as the result of correcting the gain, static bias/offset, and misalignment among the three axes. In the embodiment, these calibrations are carried out at a manufacturing plant or the like at the time of manufacturing the HMD 100.

In the calibrations on the camera 60 executed in the independent calibration, internal parameters of the camera 60 including focal length, skew, principal point, and distortion are calibrated. A known technique can be employed for the calibration on the camera 60.

After the calibration on each sensor included in the IMU 71 is executed, the detection values (measured outputs) from the respective sensors for acceleration, angular velocity, and geomagnetism in the IMU 71 are combined. Thus, IMU orientation with high accuracy can be realized.

In the embodiment, as described later, the pose of a real object is improved. An outline of the pose improvement will now be described. The pose improvement is important in real object detection and pose estimation (OD/PE) and can be utilized in various applications such as augmented reality, robot, or self-driving car.

The method in the embodiment includes an appearance-based method called a model alignment method (MA) and a method called a contour feature element method (CF). The appearance-based method is a method in which the color of a pixel in the foreground and the color of a pixel in the background are optimized. The contour feature element method is an edge-based method in which the correspondence between a 3D model and 2D image points is established using an outer contour line of a real object.

The MA method and the CF method are based solely on intensity image data. In the embodiment, a 3D surface-based method using depth image data is used as well. The methods in the embodiment are based on the iterative closest point (ICP) algorithm. With the iterative closest point algorithm, the correspondence between points is established by using the shortest Euclidean distance within a predetermined neighbor discovery (or search) size as a reference.

Since some of initial poses are largely deviated from the real pose, a neighbor discovery size is selected, adaptively based on depth verification scores. In the embodiment, this algorithm is called an adapted iterative closes point (a-ICP) method.

A scenario which has a high degree of difficulty in the OD/PE (that is, challenging) and the pose improvement is to carryout in an untidy environment (complicated or cluttered background). A precondition in this case is that most of the real object is still visible (that is, the occlusion is slight).

The performance of the MA method drops generally in an untidy scenario because the foreground and the background can no longer be discriminated from each other even if the appearance is used. Thus, the embodiment focuses on a pose improvement algorithm using the CF method and the a-ICP method.

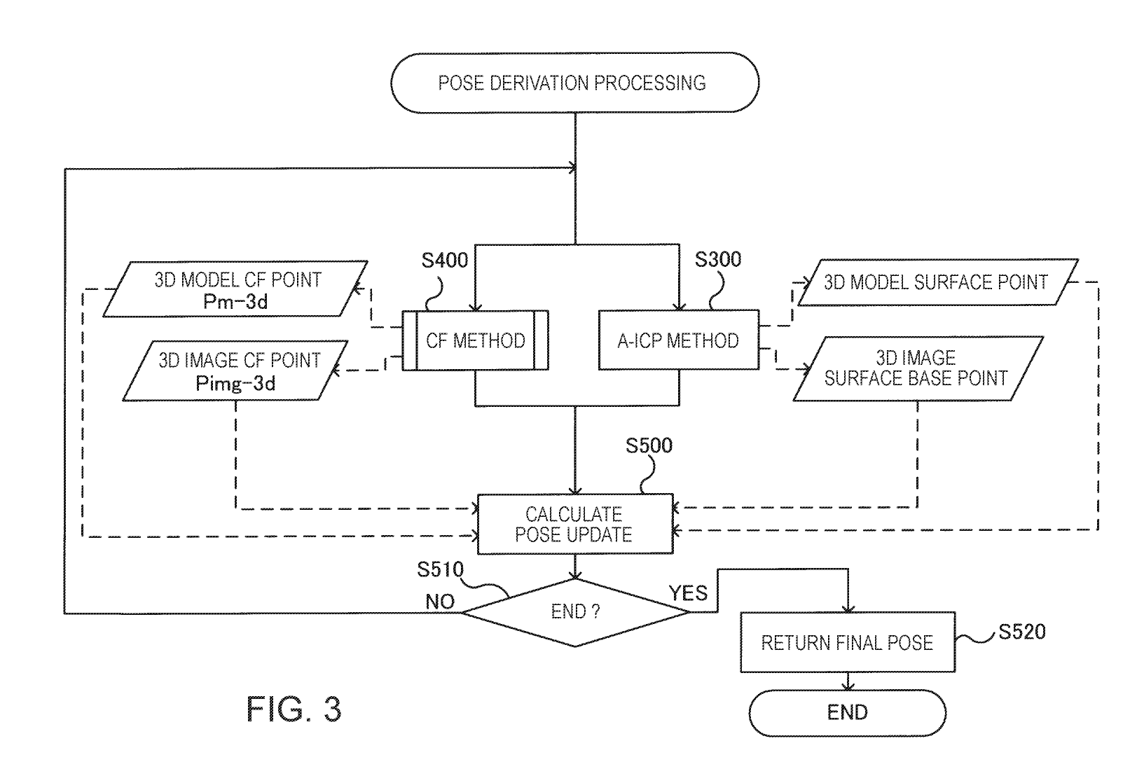

FIG. 3 is a flowchart showing the pose derivation processing. This flowchart is for deriving the pose of a real object, combining the CF method and the a-ICP method. Therefore, either the acquisition of data by the CF method or the acquisition of data by the a-ICP method may be carried out first. In the description below, the a-ICP method is carried out first. The 3D model in the embodiment is a model prepared using 3D CAD.

First, information of 3D model surface points and 3D image surface-based points is acquired using the a-ICP method (S300).

Here, the a-ICP method will be described. The a-ICP method is based on the ICP method. The ICP method refers to an algorithm used to minimize the difference between two point clouds, as described above. Since the ICP method is known, its outline will be briefly described.

The 3D model surface points form a point cloud (a set of points) associated with surface feature elements on a 3D model corresponding to the real object. The 3D model is prepared in advance. The 3D model surface points are predetermined. The 3D model surface points are also referred to as a first 3D model point cloud.

The 3D image surface-based points are data acquired from the current depth image sensor and form a 3D surface point cloud. That is, the 3D image surface-based points are data representing the distance to each of surface feature elements of the real object.

The ICP method decides the pose of the 3D model in such a way that the difference in position between the 3D model surface points and the 3D image surface-based points is minimized. However, in the embodiment, since the pose is improved in S500, the pose of the 3D model is not decided in S300.

The a-ICP is the abbreviation of adapted iterative closes point. That is, the a-ICP method refers to an adapted ICP method. The term “adapted” means that the pose is roughly aligned if the current pose is not similar to the final pose, whereas the pose is finely aligned if the current pose is similar to the final pose.

Specifically, using two different ICP parameters, either rough alignment or fine alignment is achieved. The two parameters are as follows.

The first parameter is a parameter representing how finely the point cloud is sampled. At rough levels, an overall combination is emphasized. That is, a combination using an overall shape based a roughly sampled point cloud is emphasized. Meanwhile, at fine levels, the combination of points is emphasized.

The second parameter is a parameter representing the size of the neighbor discovery range for establishing the correspondence.

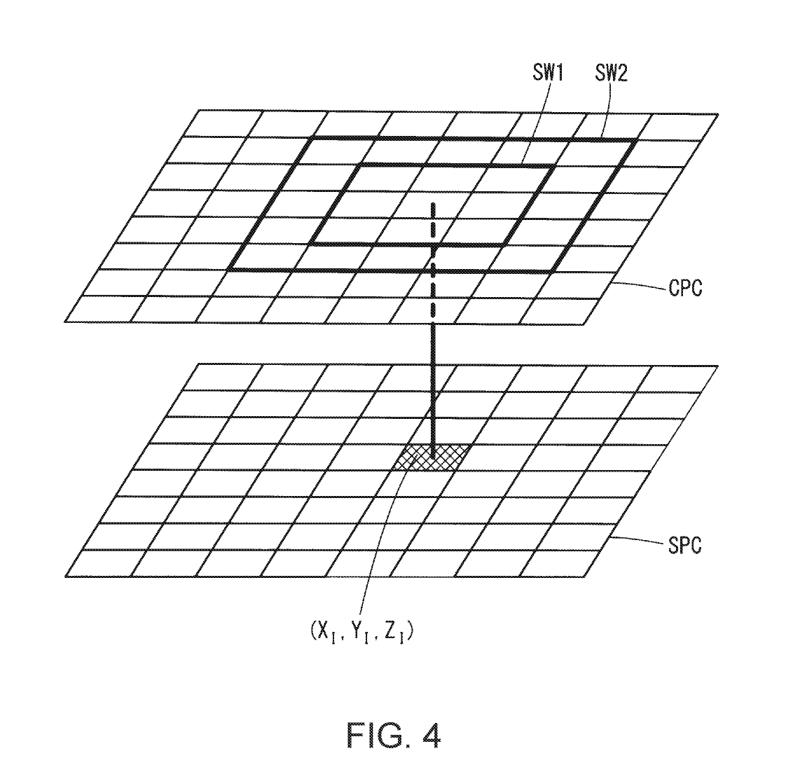

FIG. 4 shows neighbor discovery ranges. In FIG. 4, a neighbor discovery range SW1 at a finer level and a neighbor discovery range SW2 at a rougher level are shown. The neighbor discovery ranges SW1, SW2 define ranges to search in a CAD point cloud CPC, corresponding to points (X_{I}, Y_{I}, Z_{I}) included in a scene point cloud SPC.

In FIG. 4, the scene point cloud SPC is expressed in a structured (mesh-like) two-dimensional arrangement. The CAD point cloud CPC is expressed in a structured two-dimensional arrangement formed by re-projection using the current view of the real object.

The neighbor discovery range SW2 at the rougher level enables finding out the correspondence between points which are distant from each other. Consequently, it is possible for the point cloud to move over a long distance.

Meanwhile, the neighbor discovery range SW1 at a finer level places limitation so as to prevent the pose estimation by the CPU 140 from diverging from the true pose.

Using a-ICP method, N_{aICP} (in the embodiment, significantly more than 100) combinations of 3D model surface points and 3D image surface-based points are acquired. That is, the relationship between the pose of the real object that is acquired most recently and the current (latest) depth image data is acquired with respect to N_{aICP} surface feature elements. The most recently acquired pose is the pose in a frame before the current frame. The most recently acquired pose is also referred to as a first pose.

As described later, the first pose is improved in S500 and thus turns into a second pose. The second pose is the pose in the current frame. The second pose serves as the first post in the next S300 and S400.

Subsequently, using the CF method, N_{CF} (in the embodiment, 100) combinations of 3D model CF points Pm-3d and 3D image CF points Pimg-3d are acquired (S400).

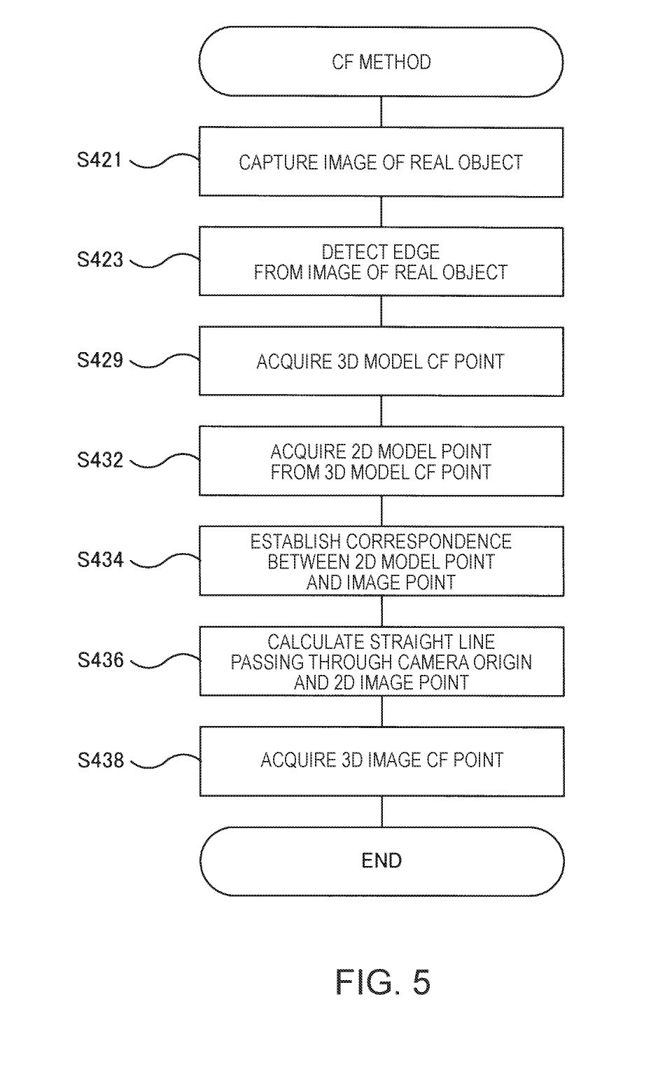

FIG. 5 is a flowchart showing the CF method. First, an image of a real object is captured using the camera 60 (S421). The image acquired in S421 is intensity image data including a plurality of image points on the real object, and its background.

Subsequently, edge detection is executed on the captured image of the real object (S423). For the edge detection, feature elements to form an edge are calculated, based on pixels in the captured image. In the embodiment, the gradient vector (also referred to simply as “gradient”) of intensity of each pixel in the captured image of the real object is calculated, thereby deciding feature elements. In the embodiment, in order to detect an edge, edges are simply compared with a threshold and those not reaching the maximum are suppressed (non-maxima suppression), as in the procedures of the Canny edge detection method.

Next, 3D model CF points Pm-3d are acquired (S429). The 3D model CF points Pm-3d form a point cloud associated with contour feature elements on a 3D model in a first pose. The first pose used in the CF method is the same as the first pose used in the a-ICP method. The contour feature elements are predetermined on the 3D model. The 3D model CF points Pm-3d are also referred to as a second 3D model point cloud. The 3D model CF points Pm-3d are represented on a 3D coordinate system (3D model coordinate system) with its origin fixed to the 3D model.

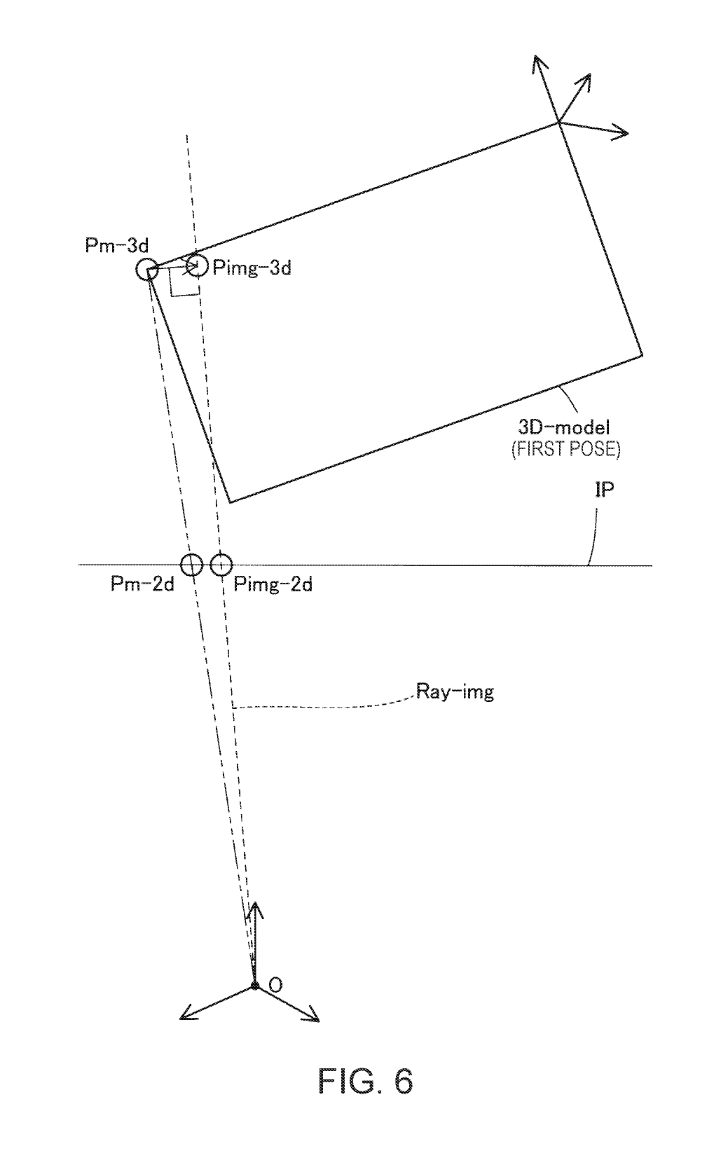

Next, based on the 3D model CF points Pm-3d, 2D model points Pm-2d are acquired (S432). FIG. 6 is a conceptual view showing how S432 to S438 are carried out. S432 is realized by projecting the 3D model CF points Pm-3d onto an image plane IP, based on the first pose. The image plane IP is synonymous with the sensor surface of the camera 60. The image plane IP is a virtual plane. The 2D model points Pm-2d are represented on a 2D coordinate system (image plane coordinate system) with its origin placed on the image plane IP.

In circumstances where the first pose of the 3D model cannot be used, 3D model CF points Pm-3d cannot be acquired from the 3D model and hence the 2D model points Pm-2d cannot be acquired based on the 3D model CF points Pm-3d. Such circumstances can take place in the case of executing initialization or re-initialization. The initialization is the case of detecting the pose of the real object for the first time. The re-initialization is the case of detecting the pose of the real-object again if the pose of the real object is detected and then lost.

In such cases, 2D model points Pm-2d are acquired by using a 2D template, instead of S429 and S432. Specifically, the following procedures are taken.

First, from among a plurality of 2D templates that are stored, a 2D template generated from a view that is the closest to the pose of the real object captured in the image is selected. The 2D template corresponds to the real object captured in the image and reflects the position and pose of the real object. The control section 10 stores a plurality of 2D templates in advance.

Here, each 2D template is data prepared based on each 2D model obtained by rendering the 3D model corresponding to the real object onto the image plane IP based on each view.

A view includes a three-dimensional rigid body conversion matrix representing rotation and translation with respect to a virtual camera and a perspective image (perceptive projection) conversion matrix including camera parameters. Specifically, each 2D template includes 2D model points Pm-2d corresponding to contour feature elements included in the contour (outer line) of the 2D model, 3D model CF points Pm-3d corresponding to the 2D model points Pm-2d, and the view. In the case of using a 2D template, feature points on the 2D model are acquired as 2D model points Pm-2d.

After the 2D model points Pm-2d are acquired, the correspondence between image points included in the edge of the image of the real object and the 2D model points Pm-2d is established (S434).

In the embodiment, in order to establish the correspondence, first, similarity scores are calculated using the following equation (1), for all of the image points included in the local vicinities of each of the projected 2D model points.

$$SIM ( p , {p}^{′} ) = \vert {\to }_{{E}_{p}} \cdot {\to }_{∇} {I}_{{p}^{′}} \vert / {max}_{q ∈ N ( p )} ‖ {\to }_{∇} {I}_{p} ‖ \qquad ( 1 )$$

In the equation (1), p represents the 2D model point Pm-2d, and p′ represents the image point. The indicator of the similarity score expressed by the equation (1) is based on the coincidence between the gradient of intensity of the 2D model point Pm-2d and the gradient of the image point. However, in the equation (1), as an example, the indicator of the similarity score is based on the inner product of the two vectors. The vector of Ep in the equation (1) is the unit length gradient vector of the 2D model points Pm-2d (edge point).

In the embodiment, when finding similarity scores, ΔI, which is the gradient of a test image (input image), is used in order to calculate feature elements of the image point p′. The normalization of the magnitude of the gradient with a local maximum value, expressed by the denominator of the equation (1), ensures that priority is given to an edge with locally high intensity. This normalization prevents collation with an edge that is weak and may result in noise.

In the embodiment, when finding similarity scores, the size N(p) of the vicinity range where the correspondence is searched for can be enhanced. For example, in continuous iterative calculations, if the average of the positional displacements of the projected 2D model points Pm-2d is decreased, N(p) can be reduced. Hereinafter, a specific method for establishing the correspondence using the equation (1) will be described as an example.

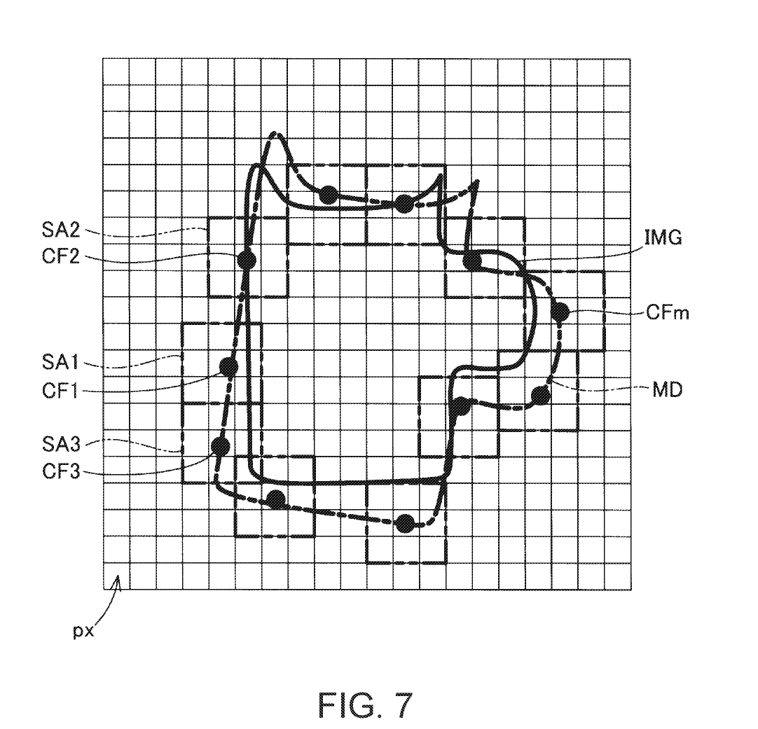

FIGS. 7 to 11 show an example of a method for establishing the correspondence between 2D model points Pm-2d and image points, based on similarity scores. In FIG. 7, an image IMG (solid line) of a real object captured by the camera 60, a 2D model MD (chain-dotted line), and contour feature elements CFm as 2D model points Pm-2d are shown. The 2D model MD is a two-dimensional contour line obtained by projecting a 3D model in the first pose onto the image plane IP.

In FIG. 7, a plurality of pixels px arranged in the form of a lattice, and areas formed by three by three pixels with each of the contour feature elements CFm situated at the center (for example, area SA1) are shown.

In FIG. 7, an area SA1 with a contour feature element CF1 situated at its center, an area SA2 with a contour feature element CF2 situated at its center, and an area SA3 with a contour feature element CF3 situated at its center are shown, as described later.

The contour feature element CF1 and the contour feature element CF2 are contour feature elements next to each other. Similarly, the contour feature element CF1 and the contour feature element CF3 are contour feature elements next to each other. In other words, the contour feature elements are arranged in the order of the contour feature element CF2, the contour feature element CF1, and the contour feature element CF3.

Since the image IMG of the real object and the 2D model MD do not coincide with each other, as shown in FIG. 7, the correspondence between image points included in the edges of the image IMG of the real object and 2D model points Pm-2d represented by each of a plurality of contour feature elements CFm is established, using the equation (1).

First, the one contour feature element CF1 of the plurality of contour feature elements CFm is selected, and the area SA1 made up of three by three pixels in which the pixel px corresponding to the position of the contour feature element CF1 is situated at its center is extracted.

Next, the area SA2 and the area SA3 each of which is made up of three by three pixels and in which the contour feature element CF2 and the contour feature element CF3 both next to the contour feature element CF1 are situated at their respective centers, are extracted.

In the embodiment, scores are calculated using the equation (1), for each pixel px forming each of the areas SA1, SA2 and SA3. At this stage, all of the areas SA1, SA2 and SA3 are matrices having the same shape and the same size.

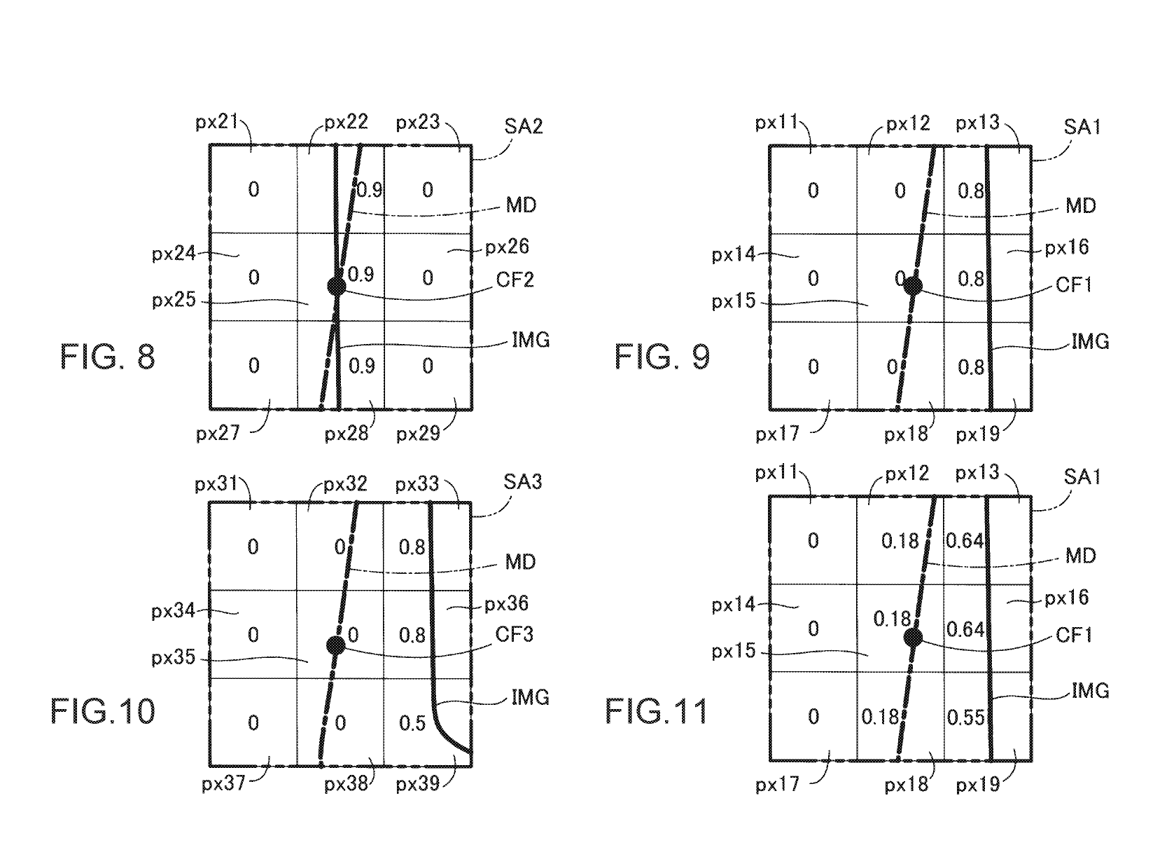

FIG. 8 shows an enlarged view of the area SA2 and similarity scores calculated for each pixel forming the area SA2. FIG. 9 shows an enlarged view of the area SA1 and similarity scores calculated for each pixel forming the area SA1. FIG. 10 shows an enlarged view of the area SA3 and similarity scores calculated for each pixel forming the area SA3.

In the embodiment, similarity scores between the 2D model point as the contour feature element and each of nine image points, in the extracted areas, are calculated. For example, in the area SA3 of FIG. 10, the pixels px33 and px36 score 0.8, the pixel px39 scores 0.5, and the other six pixels score 0.

The difference in score, that is, the pixels px33 and px36 scoring 0.8 and the pixel px39 scoring 0.5, is due to the curving of the image IMG of the real object at the pixel px39, causing the gradient to differ. As described above, similarity scores are calculated by a similar method for each pixel (image point) forming the extracted areas SA1, SA2 and SA3.

Hereinafter, the description focuses on the contour feature element CF1 (FIGS. 9 and 11). Corrected scores for each pixel forming the area SA1 are calculated (FIG. 11). Specifically, for each pixel forming the area SA1, similarity scores are averaged with a weight coefficient, using the pixels situated at the same matrix positions in each of the areas SA2 and SA3.

Such correction of similarity scores is executed not only on the contour feature element CF1 but also on each of the other contour feature elements CF2 and CF3. This has the effect of smoothing the correspondence between the 2D model point and image points.

In the embodiment, corrected scores are calculated, using a weight coefficient of 0.5 for the score of each pixel px in the area SA1, a weight coefficient of 0.2 for the score of each pixel px in the area SA2, and a weight coefficient of 0.3 for the score of each pixel px in the area SA3.

For example, as shown in FIG. 11, the corrected score of 0.55 of the pixel px19 is a value obtained by adding the score of 0.8 of the pixel px19 in the area SA1 multiplied by the weight coefficient of 0.5, the score of 0 of the pixel px29 in the area SA2 multiplied by the weight coefficient of 0.2, and the score of 0.5 of the pixel px39 in the area SA3 multiplied by the weight coefficient of 0.3.

The weight coefficients are inversely proportional to the distances between the contour feature element CF1 as the processing target and the other contour feature elements CF2 and CF3.

In the embodiment, the image point having the highest score, of the corrected scores of the pixels forming the area SA1, is decided as the image point corresponding to the contour feature element CF1.

For example, the highest value of the corrected scores is 0.64 of the pixels px13 and px16. If a plurality of pixels has the same corrected score, the pixel px16 with the shortest distance from the contour feature element CF1 is chosen and the pixel px16 is made to correspond to the contour feature element CF1.

By comparing the edge detected in the image of the real object (candidate of a part of the contour) and the 2D model points Pm-2d (contour feature elements CF), image points of the real object corresponding to the respective 2D model points Pm-2d are decided. Thus, the image points corresponding to the 2D model points Pm-2d included in the contour feature elements are called 2D image points Pimg-2d. As another method for searching for the correspondence between 2D model points and image points, the following method may be employed instead of the above method. First, similarity scores or corrected scores are derived for a plurality of image points falling on a line segment which is perpendicular to the contour line of the 2D model and passes through the 2D model point Pm-2d. Then, the image point having the highest similarity/corrected score on the line segment is defined as the 2D image point Pimg-2d corresponding to the 2D model point Pm-2d.

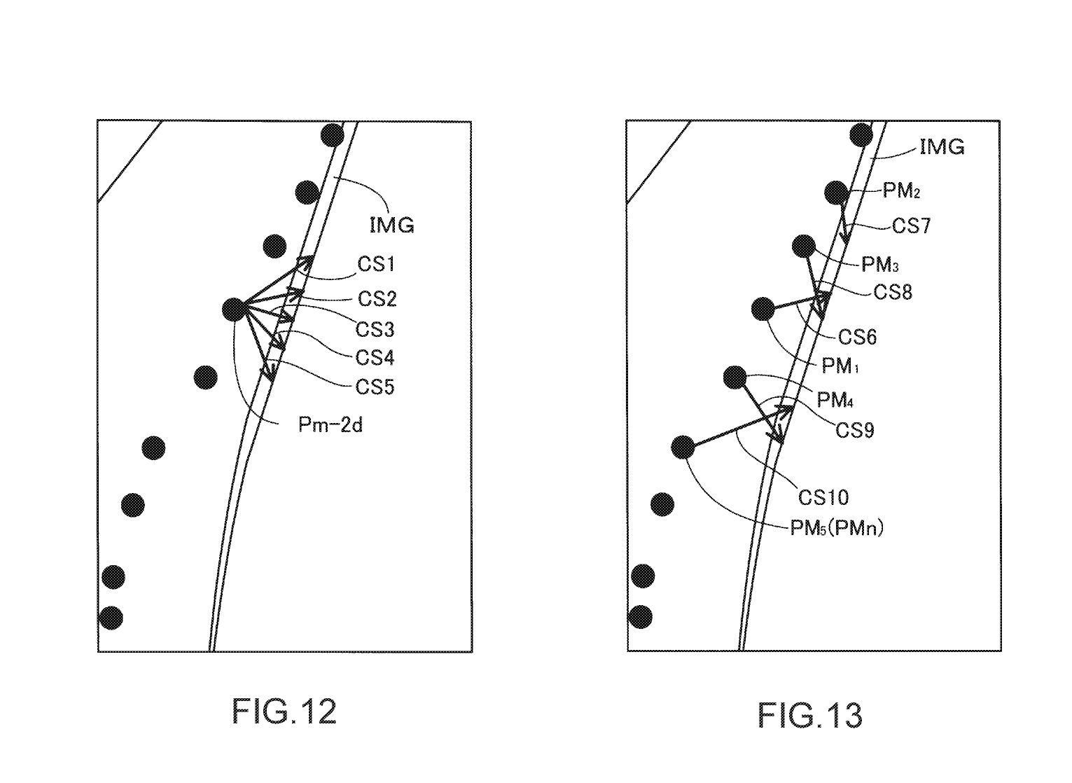

FIGS. 12 and 13 show the correspondence that can occur if the above method is not employed in procedures for establishing correspondence. By using the method according to the embodiment to establish the correspondence between 2D model points Pm-2d and image points, the possibility of errors as shown in FIG. 12 or FIG. 13 can be reduced.

FIGS. 12 and 13 show enlarged views of a part of the captured image IMG of the real object and a set PMn of 2D model points Pm-2d, and a plurality of arrows CS.

FIG. 12 shows that one 2D model point Pm-2d can be matched with multiple image points included in one edge. That is, there is a plurality of options such as arrows CS1 to CS5 to decide which part of the edge detected as the image IMG of the real object the 2D model point Pm-2d corresponds to.

FIG. 13 shows an example in which 2D model points Pm-2d are matched with wrong image points. Specifically, a plurality of 2D model points PM1 to PM5 are wrongly matched with (image points included in) the edge detected as the image IMG of the real object.

In this case, for example, even if the 2D model points are arranged in the order of PM2, PM3, PM1, PM4 and PM5 from the top in FIG. 13, the arrows are arranged in the order of CS7, CS6, CS8, CS10 and CS9 as the edge of the image IMG of the real object. Therefore, the arrows CS8 and CS6, and the arrows CS9 and CS10 are switched.

Back to FIG. 6, imaginary lines Ray-img passing through a camera origin O (origin of the camera coordinate system) and respective 2D image points Pimg-2d is calculated (S436). The imaginary line Ray-img is a straight line defined on the 3D coordinate system.

Finally, 3D image CF points Pimg-3d are acquired (S438). The 3D image CF points Pimg-3d are also referred to as 3D image contour points. The 3D image CF points Pimg-3d are acquired by projection from the corresponding 3D model CF points Pm-3d to the corresponding imaginary line Ray-img. Specifically, a 3D image CF point Pimg-3d is the foot of a perpendicular line drawn from the corresponding 3D image CF point Pimg-3d to the corresponding imaginary line Ray-img.

As described above, using the CF method, N_{CF} combinations of 3D model CF points Pm-3d and 3D image CF points Pimg-3d are acquired.

Next, the update of the pose is calculated (S500). The pose in the current frame is derived in S500. The pose thus derived is called a second pose. The second pose is derived, based at least on the 3D mode surface points (first 3D model point cloud), the 3D image surface-based points (3D surface point cloud), the 3D model CF points Pm-3d (second 3D model point cloud), and the 3D image CF points Pimg-3d.

If a 3D point correspondence (p, p′) set made up of N points is given, the pose is optimized by finding R and T that minimize the sum of squares (Σ²) of the distance difference. The sum of squares of the distance difference is calculated by the following equation.

$${Σ}^{2} = {\sum }_{i = 1}^{N} {‖ {p}_{i}^{′} - ( {Rp}_{i} + T ) ‖}^{2} \qquad ( 2 )$$

R in the equation (2) is a rotating element in a conversion matrix. T in the equation is a translating element in the conversion matrix.

These can easily be linearly coupled with respect to both the CF data and the a-ICP data expressed from 3D to 3D domain. However, in the embodiment, the origin on the camera 60 coordinate system (3D coordinate system of the RGB image sensor) and the origin on the distance camera coordinate system (3D coordinate system of the depth image sensor 80) are different from each other. Therefore, in the embodiment, each correspondence set is converted to a common coordinate system (for example, the 3D coordinate system of the robot or the 3D coordinate system of the display section 20 of the HMD 100). The minimization function after this conversion is simply the linear sum of error terms.

$${Σ}^{2} = {\sum }_{i = 1}^{{N}_{aICP}} {‖ {Dp}_{i}^{′} - ( {DRp}_{i} + T ) ‖}^{2} + {\sum }_{j = 1}^{{N}_{CF}} {‖ {Cp}_{j}^{′} - ( {RCp}_{j} + T ) ‖}^{2} \qquad ( 3 )$$

D in the equation is a conversion matrix and represents “basic change” from the distance camera coordinate system to the common coordinate system. C in the equation is a conversion matrix and represents “basic change” from the camera coordinate system to the common coordinate system with respect to each color.

R and T in the equation are closed-form solutions (analytical solutions) of the equation (3). Therefore, in the search for the minimum value of the function, a nonlinear least squares method such as the Gauss-Newton method is not necessary.

After S500, whether to end the improvement of the pose or not is determined (S510). That is, whether to carry out S500 repeatedly or not is determined. If the improvement of the pose is not to end (S510, NO), S300 to S500 are executed again. Thus, the derivation of a conversion matrix (R and T) corresponding to the acquired image frame is continued and consequently the pose of the real object can be tracked.

If the improvement of the pose is to end (S510, YES), the final pose is returned (S520). That is, the conversion matrix (R and T) calculated in the most recent S500 is outputted.

According to the processing described above, disadvantages observed in the case where each of the pose improvement method based on the CF method and the pose improvement method based on the a-ICP method is independently used. Advantages of the CF method and the a-ICP method will now be described.

An advantage of the CF method is that high accuracy is secured in a clean (isolated) state. The clean state refers to the state where the contour can be clearly distinguished from the background.

A disadvantage of the CF method is that accuracy may be low in an untidy state, particularly with respect to dark real objects whose outer edges are confused with each other. Also, the method is not always robust to the scaling of real objects but this can be improved by using a stereo camera or multiple cameras.

An advantage of the a-ICP method is that high accuracy is secured both in the clean state and in the untidy state.

A disadvantage of the a-ICP method is that accuracy may be low with respect to real objects having very ordinary surfaces (surface with no particular features) such as a flat surface or cylinder. This is because the correspondence between neighboring points has high ambiguity.

As described above, the disadvantage of the CF method and the disadvantage of the a-ICP method can be regarded as independent of each other. Therefore, according to the embodiment, the pose can be accurately derived by compensating for the disadvantages of the two methods.

This disclosure is not limited to the embodiments, examples and modifications described in the specification and can be realized with various other configurations without departing from the scope of the disclosure. For example, technical features in the embodiments, examples and modifications corresponding to technical features in each configuration described in the summary section can be adaptively replaced or combined in order to solve a part or the entirety of the foregoing problems or in order to achieve a part or the entirety of the foregoing advantageous effects. Such technical features can be adaptively deleted unless described as essential in the specification. For example, the following examples can be employed.

The first pose need not be a pose in a frame preceding the current frame. For example, the pose of the real object acquired from the camera 60 (image sensor) may be used as the first pose. In the case of acquiring the pose of the real object from the camera 60, the a-ICP method may be used and the ICP may be used as well.

Alternatively, the pose of the real object acquired from the depth image sensor 80 may be used as the first pose. In the case of acquiring the pose of the real object from the depth image sensor 80, the CF method may be used.

As described above, in the case where the first pose is derived based on the camera 60 or another image sensor (depth image sensor 80), processing load is reduced.

The ratio of the number of CF points to the number of a-ICP points may be adaptively set. The number of a-ICP points can vary depending on the adaptation level. However, in any case, the number of a-ICP points is much greater than the number of CF points. The sampling of a-ICP points can change in such a way as to realize a function of local geometry (geometric structure). For example, a flat area communicates little descriptive information and therefore does not need dense sampling.

A reliability element may be added to the correspondence of 3D points. The reliability element is a coefficient representing reliability. This can be done by introducing a N×N diagonal matrix. Here, each diagonal element is the reliability element of each point. The reliability element can be calculated, based on the magnitude of the gradient vector of the CF point, for example. Alternatively, the reliability element can be calculated, based on the surface ambiguity of the a-ICP point.

The number of adaptation levels in the a-ICP method may be adaptively changed.

The device which executes the pose derivation processing may be any device having a computing function. For example, a video see-through HMD may be employed, and devices other than the HMD may be employed as well. The devices other than the HMD may include a robot, portable display device (for example, smartphone), head-up display (HUD), or stationary display device.

In the above description, a part or the entirety of the functions and processing realized by software may be realized by hardware. Meanwhile, a part or the entirety of the functions and processing realized by hardware may be realized by software. As the hardware, various circuits may be used such as an integrated circuit, discrete circuit, or circuit module made up of a combination of these.

The entire disclosure of Japanese Patent Application No. 2016-227595, file on Nov. 24, 2016, is incorporated by reference herein.

What is claimed is:

1. A non-transitory storage medium containing program instructions that, when executed by a processor, cause the processor to perform a method comprising:
obtaining a first 3D model point cloud associated with surface feature elements of a 3D model corresponding to a real object in a scene, the first 3D model point cloud being on the 3D model;
obtaining a 3D surface point cloud from current depth image data of the real object captured with a depth image sensor;
obtaining a second 3D model point cloud associated with 2D model points in a model contour that is obtained from projection of the 3D model onto an image plane using a first pose of the 3D model, the second 3D model point cloud being on the 3D model;
obtaining a 3D image contour point cloud at respective intersections of first imaginary lines and second imaginary lines, the first imaginary lines passing through image points and the origin of a 3D coordinate system of an image sensor, the image points being obtained from current intensity image data of the real object captured with the image sensor and corresponding to the 2D model points included in the model contour, the second imaginary lines passing through the second 3D point cloud and being perpendicular to the first imaginary lines; and
deriving a second pose based at least on the first 3D model point cloud, the 3D surface point cloud, the second 3D model point cloud, the 3D image contour point cloud and the first pose.

2. The non-transitory storage medium according to claim 1,
wherein
the first pose is a pose of the real object in a frame before a current frame of the depth image data or the intensity image data, and
the second pose is a pose of the real object in the current frame of the depth image data or the intensity image data.

3. The non-transitory storage medium according to claim 1,
wherein
the first pose is a pose obtained from the image sensor or another image sensor.

4. A method for deriving a pose of a real object in a scene comprising steps of:
obtaining a first 3D model point cloud associated with surface feature elements of a 3D model corresponding to a real object in a scene, the first 3D model point cloud being on the 3D model;
obtaining a 3D surface point cloud from current depth image data of the real object captured with a depth image sensor;
obtaining a second 3D model point cloud associated with 2D model points in a model contour that is obtained from projection of the 3D model onto an image plane using a first pose of the 3D model, the second 3D model point cloud being on the 3D model;
obtaining a 3D image contour point cloud at respective intersections of first imaginary lines and second imaginary lines, the first imaginary lines passing through image points and the origin of a 3D coordinate system of an image sensor, the image points being obtained from current intensity image data of the real object captured with the image sensor and corresponding to the 2D model points included in the model contour, the second imaginary lines passing through the second 3D point cloud and being perpendicular to the first imaginary lines; and
deriving a second pose based at least on the first 3D model point cloud, the 3D surface point cloud, the second 3D model point cloud, the 3D image contour point cloud and the first pose.

5. A pose derivation device comprising:
a function of obtaining a first 3D model point cloud associated with surface feature elements of a 3D model corresponding to a real object in a scene, the first 3D model point cloud being on the 3D model;
a function of obtaining a 3D surface point cloud from current depth image data of the real object captured with a depth image sensor;
a function of obtaining a second 3D model point cloud associated with 2D model points in a model contour that is obtained from projection of the 3D model onto an image plane using a first pose of the 3D model, the second 3D model point cloud being on the 3D model;
a function of obtaining a 3D image contour point cloud at respective intersections of first imaginary lines and second imaginary lines, the first imaginary lines passing through image points and the origin of a 3D coordinate system of an image sensor, the image points being obtained from current intensity image data of the real object captured with the image sensor and corresponding to the 2D model points included in the model contour, the second imaginary lines passing through the second 3D point cloud and being perpendicular to the first imaginary lines; and
a function of deriving a second pose based at least on the first 3D model point cloud, the 3D surface point cloud, the second 3D model point cloud, the 3D image contour point cloud and the first pose.
